(19) United States
(12) Patent Application Publication
(10) Pub. No.: US 2013/0155010 A1
(43) Pub. Date: Jun. 20, 2013

(54) Capacitive Proximity Based Gesture Input System

(71) Applicant: MICROCHIP TECHNOLOGY INCORPORATED, Chandler, AZ (US)

(72) Inventors: Keith Edwin Curtis, Gilbert, AZ (US); Fanie Duvenhage, Phoenix, AZ (US)

(73) Assignee: MICROCHIP TECHNOLOGY INCORPORATED, Chandler, AZ (US)

(21) Appl. No.: 13/693,557

(22) Filed: Dec. 4, 2012

Related U.S. Application Data
(60) Provisional application No. 61/570,530, filed on Dec. 14, 2011.

(51) Int. Cl. G06F 3/044

(52) U.S. Cl. CPC G06F 3/044
USPC 345/174

(57) ABSTRACT

A plurality of capacitive proximity sensors on a substantially horizontal plane and in combination with a microcontroller are used to detect user gestures for Page Up/Down, Zoom In/Out, Move Up/Down/Right/Left, Rotation, etc., commands to a video display. The microcontroller is adapted to interpret the capacitive changes of the plurality of capacitive proximity sensors caused by the user gestures, and generate control signals based upon these gestures to control the visual content of the video display.

### RELATED PATENT APPLICATION

This application claims priority to commonly owned U.S. Provisional Patent Application Ser. No. 61/570,530; filed Dec. 14, 2011; entitled “Capacitive Proximity Based Gesture Input System,” by Keith Edwin Curtis and Fanie Duvenhage; which is hereby incorporated by reference herein for all purposes.

### TECHNICAL FIELD

The present disclosure relates to a method and apparatus for proximity detection, and, in particular, a capacitive proximity based gesture input system.

### BACKGROUND

Current document viewing software requires short-cut key combinations or pull down menus plus a mouse to control the display of the document. Keyboard and mouse interfaces are not as intuitive as gesture based systems, requiring specialized knowledge about system operation and command structure. Gesture based systems do not require specialized commands, using hand gestures that are nearly identical to the handling of a paper hardcopy.

### SUMMARY

Therefore there is a need for a gesture based system that may be used with many different information displays, such as, for example but not limited to, information (e.g., documents and data) kiosks at airports, office buildings, doctors offices, museums, libraries, schools, zoos, government and post offices, and the like. The gesture based system may be independent of the visual display and may be easily interfaced with a computer associated with the visual display, according to the teachings of this disclosure.

According to an embodiment, a human interface device may comprise: a plurality of capacitive proximity sensors arranged in pattern on a plane of a substrate; and a controller operable to measure a capacitance of each of the plurality the capacitive proximity sensors and to detect gestures by means of the plurality of capacitive proximity sensors. According to a further embodiment, the plurality of capacitive proximity sensors may be six capacitive proximity sensors arranged in the pattern on the plane of the substrate. According to a further embodiment, the pattern comprises two of the capacitive proximity sensors arranged on a distal portion of the plane, another two of the capacitive proximity sensors arranged on a proximate portion of the plane, and still another two of the capacitive proximity sensors arranged on either side portions of the plane. According to a further embodiment, the controller may be a microcontroller.

According to a further embodiment, the microcontroller may comprise: an analog front end and multiplexer coupled to the plurality of capacitive proximity sensors; a capacitance measurement circuit coupled to the analog front end and multiplexer; an analog-to-digital converter (ADC) having an input coupled to the capacitance measurement circuit; a digital processor and memory coupled to an output of the ADC; and a computer interface coupled to the digital processor. According to a further embodiment, the computer interface may be a universal serial bus (USB) interface.

According to another embodiment, a method for detecting gestures with a human interface device comprising a plurality of capacitive proximity sensors may comprise the steps of: arranging the plurality of capacitive proximity sensors in a pattern within a sensing plane; detecting a movement of at least one hand of a user at a distance from the sensing plane with at least two of the capacitive proximity sensors; and decoding and associating the detected movement to a respective one of a plurality of commands. According to a further embodiment of the method, the plurality of capacitive proximity sensors may be six capacitive proximity sensors arranged in the pattern on the sensing plane.

According to a further embodiment of the method, top left and top right capacitive proximity sensors may be arranged on a distal portion of the sensing plane, bottom left and bottom right capacitive proximity sensors may be arranged on a proximate portion of the sensing plane, and left and right capacitive proximity sensors may be arranged on either side portions of the sensing plane. According to a further embodiment of the method, a page up command may be detected when a hand moves from the right sensor to the left sensor in a sweeping motion, wherein capacitive changes in the right, bottom right, bottom left, and left sensors may be detected. According to a further embodiment of the method, a page down command may be detected when a hand moves from the left sensor to the right sensor in a sweeping motion, wherein capacitive changes in the left, bottom left, bottom right, and right sensors may be detected. According to a further embodiment of the method, a left/right/up/down command may be detected when a hand hovers over the sensors and moves in a desired direction of travel, wherein ratio metric changes in the capacitance values of the sensors may be detected.

According to a further embodiment of the method, a zoom up/down command may be detected when a hand hovers over the sensors and moves in or out of a desired direction of travel, wherein ratio metric changes in the capacitance values of the sensor may be detected. According to a further embodiment of the method, a clockwise rotation command may be detected when at least one hand hovers over the top right/right sensors and the bottom left/left sensors, and then rotates clockwise to the bottom right/right sensors and the top left/left sensors, wherein changes in the capacitance values of the top right/right sensors to the right/bottom right sensors and the bottom left/left sensors to the top left/left sensors may be detected. According to a further embodiment of the method, a counter clockwise rotation command may be detected when at least one hand hovers over the bottom right/right sensors and the top left/left sensors, and then rotates clockwise to the top right/right sensors and the bottom left/left sensors, wherein changes in the capacitance values of the bottom right/right sensors to the right/top right sensors and the top left/left sensors to the bottom left/left sensors may be detected.

### BRIEF DESCRIPTION OF THE DRAWINGS

A more complete understanding of the present disclosure may be acquired by referring to the following description taken in conjunction with the accompanying drawings wherein:

FIG. 1 illustrates a schematic isometric diagram of a display kiosk, gesture input panel and computer, according to the teachings of this disclosure;

FIG. 2 illustrates a schematic plan view diagram of gestures for rotation of a document, according to the teachings of this disclosure;

FIG. 3 illustrates a schematic plan view diagram of gestures for Zoom In/Out of a document, according to the teachings of this disclosure;

FIG. 4 illustrates a schematic plan view diagram of gestures for X/Y positioning of a document, according to the teachings of this disclosure;

FIG. 5 illustrates a schematic plan view diagram of gestures for Page Up/Down positioning of a document, according to the teachings of this disclosure; and

FIG. 6 illustrates a schematic block diagram of a gesture input panel having a plurality of capacitive proximity sensors and a microcontroller interface, according to a specific example embodiment of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

All current in use gesture systems either require contact to a touch screen, or require visual capture and differentiation of the users hand, based on a camera system mounted to the display. A system according to various embodiments is instead, based on the proximity of the user to a substantially horizontal sensor plate, which can be mounted, for example, approximately perpendicular to the visual display. This removes the gesture capture from the display system and makes it an independent peripheral adapted to easy interface with a computer.

According to various embodiments, a method for using a combination of a plurality of capacitive proximity sensors to detect gestures for Page Up/Down, Zoom In/Out, Move Up/Down/Right/Left, and Rotation is disclosed herein. The proposed gestures disclosed herein cover common document/image viewer controls, however they can be easily adapted for other human interface devices. The plurality of possible gestures are decodable using a simple data driven state machine. Thus, a single mixed signal integrated circuit or microcontroller may be used in such a human interface device. A detection state machine can also be implemented with 8-32 bit microprocessor systems requiring low program overhead.

A respective system equipped with such a gesture recognition device can replace a Mouse/Trackball interface for information displays, personal computers, workstations and/or mobile devices, etc. This methodology allows the creation of intuitive gesture based user interface systems for any document or data display, e.g., information kiosk. The plurality of capacitive proximity sensors may provide for up to about three (3) inches of proportional proximity detection. If combined with microcontrollers having integrated communications functionality, e.g., a universal serial bus (USB) interface, such a gesturing device can be beneficially used in a variety of human/machine interface devices.

Referring now to the drawings, the details of specific example gesturing embodiments and hardware implementations therefore, are schematically illustrated. Like elements in the drawings will be represented by like numbers, and similar elements will be represented by like numbers with a different lower case letter suffix.

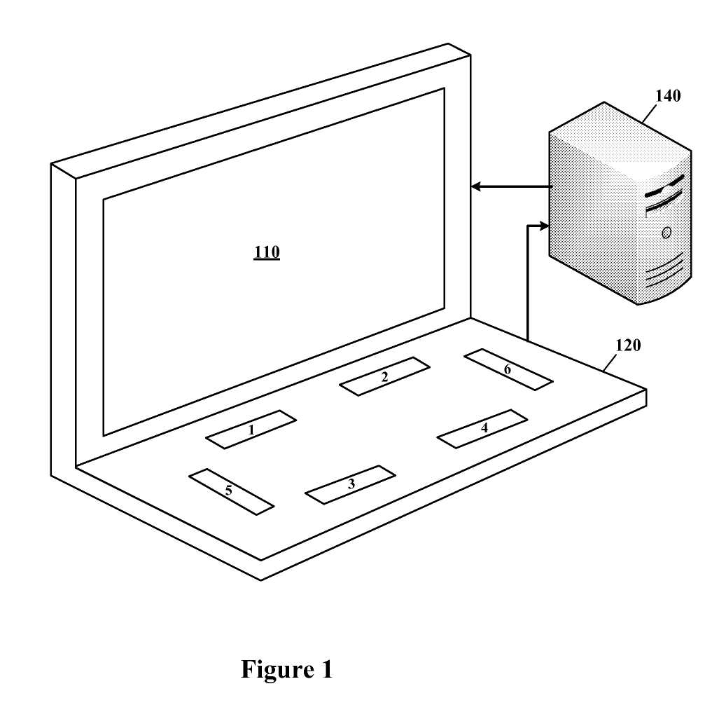

Referring to FIG. 1, depicted is a schematic isometric diagram of a display kiosk, gesture input panel and computer, according to the teachings of this disclosure. A gesture based human interface input device 120, according an embodiment disclosed herein, in combination with a visual display device 110 and a computer 140 may be used for many different information displays, such as, for example but not limited to, information (e.g., documents and data) kiosks at airports, office buildings, doctors offices, museums, libraries, schools, zoos, government and post offices, and the like. The gesture based human interface input device 120 may be independent of the visual display device 110 and may be easily interfaced with a computer 140 associated with the visual display device 110, according to the teachings of this disclosure.

As shown in FIG. 1 the gesture based human interface input device 120 may be mounted with or independent from the visual display device 110, and positioned appropriately for human gesturing interaction with images displayed on the visual display device 110. The based human interface input device 120 can be designed to detect the movement of one or both hands, and may interpret certain gestures as predefined commands that may be used interactively with the visual display device 110. The gesture based human interface input device 120 may be based upon six capacitive proximity sensors arranged as shown in FIG. 1. These six capacitive proximity sensors may be further defined as a top left sensor 1, a top right sensor 2, a bottom left sensor 3, a bottom right sensor 4, a left sensor 5 and a right sensor 6. It is also contemplated and within the scope of this disclosure that more or less capacitive proximity sensors may be utilized according to the teachings of this disclosure.

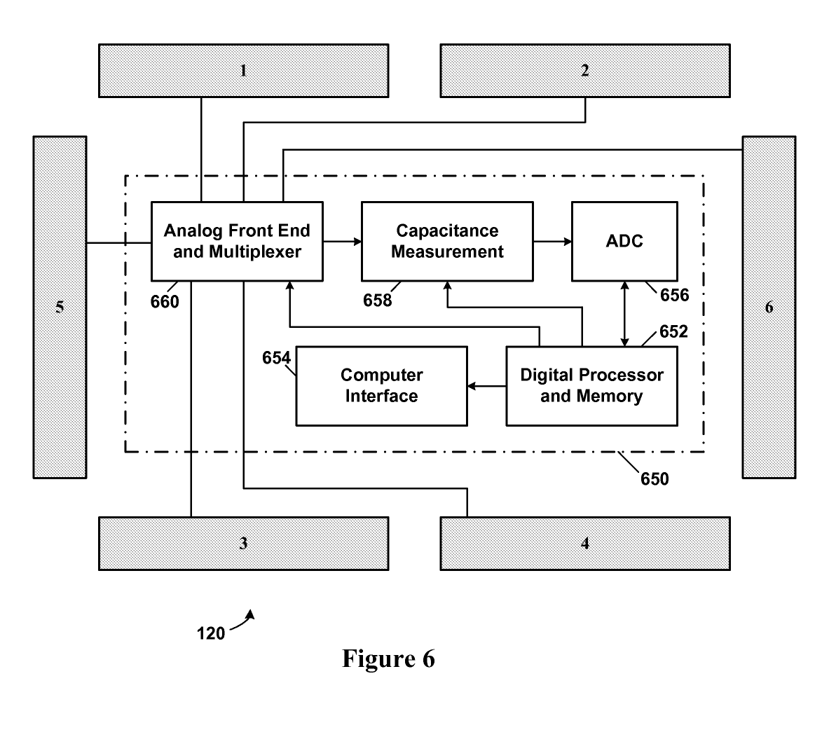

A microcontroller (see FIG. 6) preferably with a computer interface, e.g., universal serial bus (USB) interface, may be used to measure the capacitances of the individual

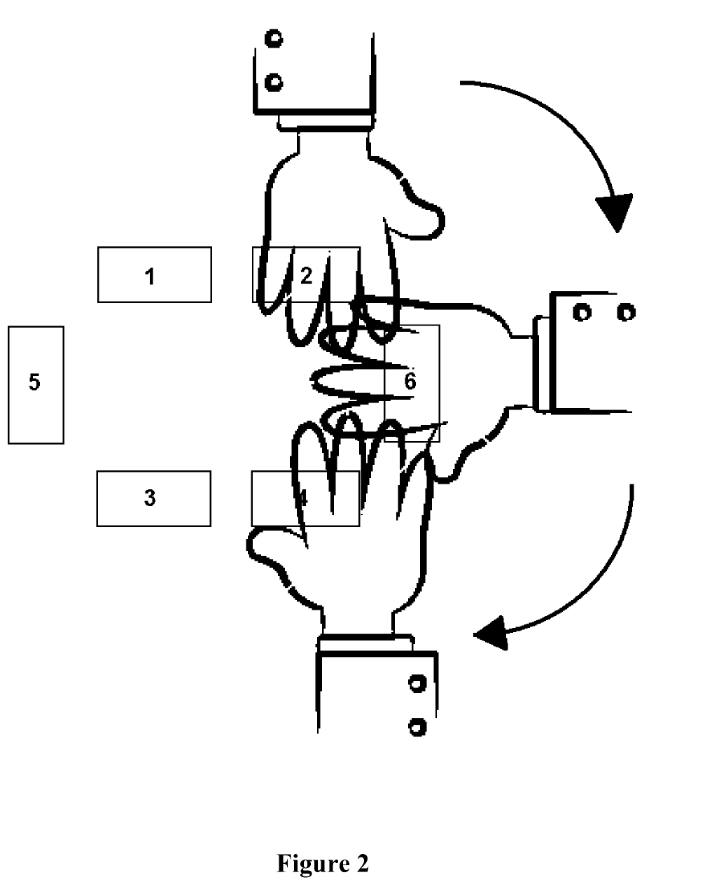

Referring to FIG. 2, depicted is a schematic plan view diagram of gestures for rotation of a document, according to the teachings of this disclosure. For rotation of a document the user places his/her hand above sensor 2, or alternately 2 and 6. The user then rotates his/her hand until it is over sensor 4, or alternately, 4 and 6.

For a clockwise rotation command, two hands may hover over the top right/right (2, 6) and bottom left/left (3, 5), and then rotate clockwise to bottom right/right (4, 6) and top left/left (1, 5). An associated recognition pattern may be: top right/right (2, 6) to right/bottom right (6, 4) plus bottom left/left (3, 5) to top left/left (1, 5).

For a counter-clockwise rotation command, two hands may hover over the bottom right/right (4, 6) and top left/left (1, 5), and then rotate clockwise to top right/right (2, 6) and bottom left/left (3, 5). An associated recognition pattern may be: bottom right/right (4, 6) to right/top right (6, 2) plus top left/left (1, 5) to bottom left/left (3, 5).

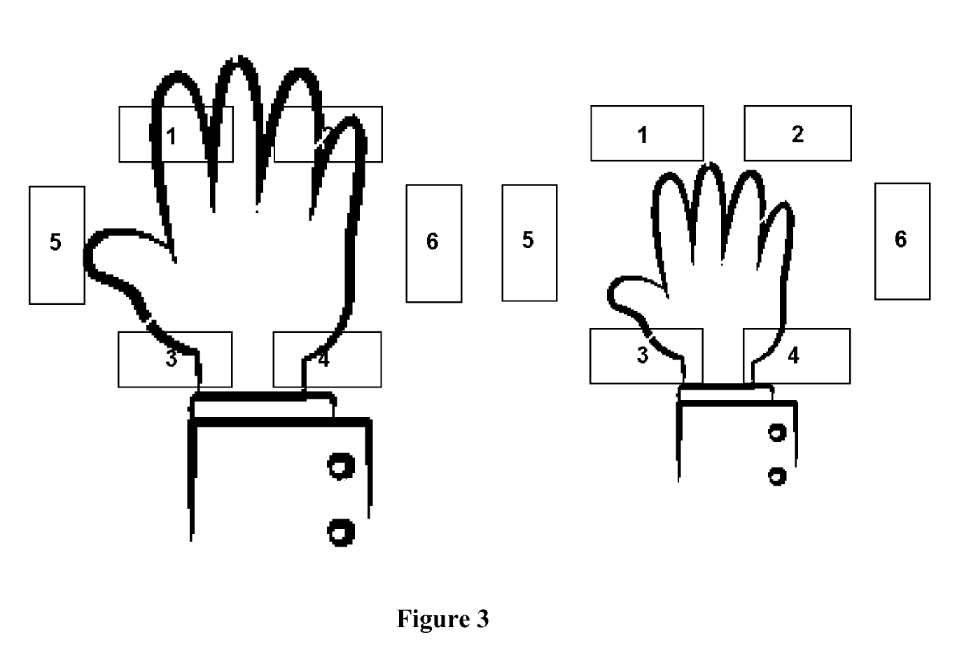

Referring to FIG. 3, depicted is a schematic plan view diagram of gestures for Zoom In/Out of a document, according to the teachings of this disclosure. For Zoom In/Out the user moves his/her hand parallel to the plane of the sensors 1-6, until his/her hand is centered over all six sensors 1-6. The user then raises or lowers his/her hand to zoom in or out. When the desire level of zoom is reached the user's hand is withdrawn horizontally.

For a Zoom In command the hand hovers over the sensors and moves toward (moves into) the sensors 1-6. For a Zoom Out command the hand hovers over the sensors and moves away from the sensors 1-6. An associated recognition pattern may be: ratio metric change in all of the sensor capacitance values.

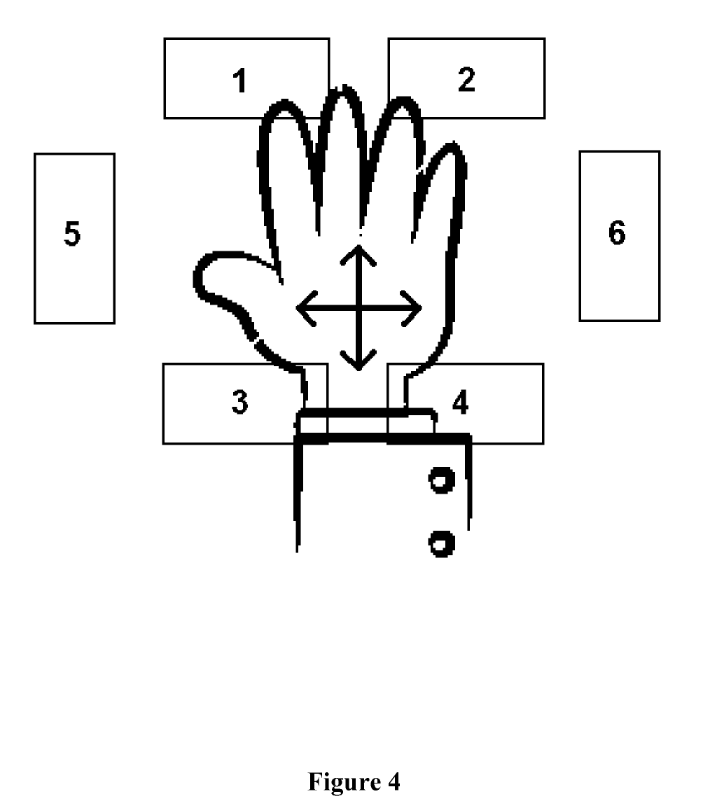

Referring to FIG. 4, depicted is a schematic plan view diagram of gestures for X/Y positioning of a document, according to the teachings of this disclosure. For X/Y positioning the user moves his/her hand vertically, into the plane of the sensors 1-6, until his/her hand is within range of all six sensors 1-6. The user then moves his/her hand in the plane of the sensors 1-6 until the appropriate position is reached. The user then removes his/her hand vertically from the sensors 1-6.

For a left/right/up/down-command, a hand hovers over the sensors and moves in the direction of the desired movement of the document. An associated recognition pattern may be ratio metric changes in the sensor capacitance values.

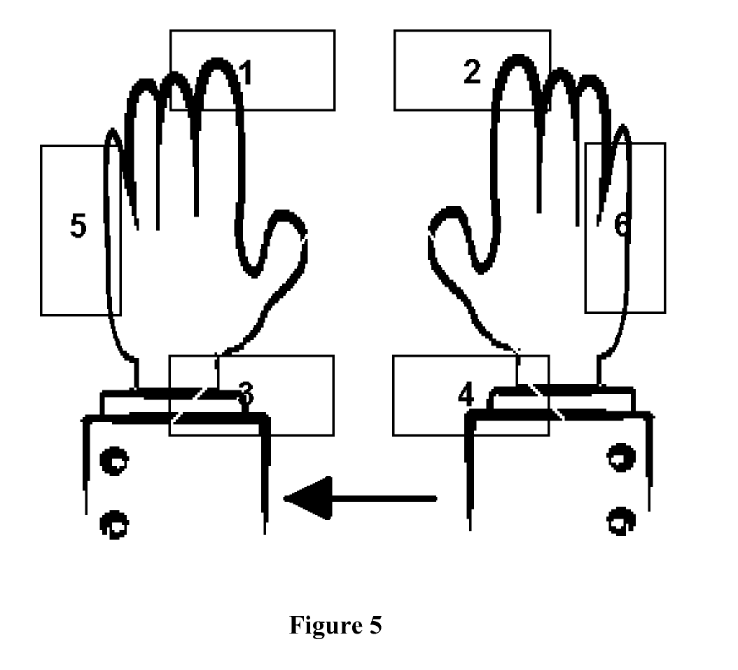

Referring to FIG. 5, depicted is a schematic plan view diagram of gestures for Page Up/Down positioning of a document, according to the teachings of this disclosure. For Page Up/Down the user may move his/her hand parallel to the plane of the sensors 1-6, until his/her hand is centered over sensor 6 for Page Down, or sensor 5 for Page Up. The user may then flip his/her hand while moving horizontally over the sensors 1-6. This action approximates the flipping of a page in a book. Once this gesture is complete, the hand can be removed parallel to the plane of the sensors.

A Page Up command may be detected when the hand moves in a sweeping motion from the right sensor 6 to the left sensor 5 in a sweeping motion. An associated sensor recognition pattern/sequence may be: right 6, bottom right 4, bottom left 3 and left 5.

A Page Down command may be detected when the hand moves in a sweeping motion from the left sensor 5 to the right sensor 6 in a sweeping motion. An associated sensor recognition pattern/sequence may be: left 5, bottom left 3, bottom right 4 and right 6.

Referring to FIG. 6, depicted is a schematic block diagram of a gesture input panel having a plurality of capacitive proximity sensors and a microcontroller interface, according to a specific example embodiment of this disclosure. A gesture input panel, generally represented by the numeral 620, may comprise a plurality of capacitive proximity sensors 1-6, a microcontroller 650 comprising a digital processor and memory 652, a computer interface 654, an analog-to-digital converter (ADC) 656, a capacitive measurement circuit 658, and an analog front end and multiplexer 660.

The analog front end and multiplexer 660 couple each of the capacitive proximity sensors 1-6 to the capacitance measurement circuit 658. The capacitance measurement circuit 658 precisely measures the capacitance value of each of the plurality of capacitive proximity sensors 1-6 as an analog voltage. The ADC 656 converts analog voltages representative of the capacitance values of the capacitive proximity sensors 1-6 into digital representations thereof. The digital processor and memory 652 reads these digital representations of the capacitance values and stores them in the memory for further processing to create commands to the computer 140 based upon the gesturing inputs described more fully hereinabove. A computer interface 654, e.g., USB, serial, PS-2, etc., may be adapted to communicate with a computer 140 that drives a visual display 110.

The capacitance measurement circuit 658 may be any one or more capacitance measurement peripherals that have the necessary capacitance measurement resolution. For example, but not limited to, a Charge Time Measurement Unit (CTMU), a capacitive voltage divider (CVD) method, and a capacitive sensing module (CSM). The CTMU may be used for very accurate capacitance measurements. The CTMU is more fully described in Microchip applications notes AN1250 and AN1375, available at www.microchip.com, and commonly owned U.S. Pat. No. 7,460,441 B2, entitled “Measuring a long time period;” and U.S. Pat. No. 7,764,213 B2, entitled “Current-time digital-to-analog converter,” both by James E. Bartling; wherein all of which are hereby incorporated by reference herein for all purposes.

The capacitive voltage divider (CVD) method determines a capacitance value and/or evaluates whether the capacitive value has changed. The CVD method is more fully described in Application Note AN1208, available at www.microchip.com; and a more detailed explanation of the CVD method is presented in commonly owned United States Patent Application Publication No. US 2010/0181180, entitled “Capacitive Touch Sensing using an Internal Capacitor of an Analog-To-Digital Converter (ADC) and a Voltage Reference,” by Dieter Peter; wherein both are hereby incorporated by reference herein for all purposes.

Capacitive sensing using the period method and a capacitive sensing module (CSM) are more fully described in Application Notes AN1101, AN1171, AN1268, AN1312, AN1334 and TB3064, available at www.microchip.com, and commonly owned U.S. Patent Application No.: US 2011/0007028 A1, entitled “Capacitive Touch System With Noise Immunity” by Keith E. Curtis, et al.; wherein all of which are hereby incorporated by reference herein for all purposes.

The proposed gestures cover common document/image viewer controls, however they can be easily adapted for other human interface devices. The plurality of possible gestures are decodable using a simple data driven state machine. Thus, a single mixed signal integrated circuit or microcontroller may be used in such a human interface device. A detection state machine can also be implemented on 8-32 bit microprocessor systems with low overhead.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A human interface device, comprising:
a plurality of capacitive proximity sensors arranged in pattern on a plane of a substrate; and
a controller operable to measure a capacitance of each of the plurality the capacitive proximity sensors and to detect gestures by means of the plurality of capacitive proximity sensors.

2. The device according to claim 1, wherein the plurality of capacitive proximity sensors are six capacitive proximity sensors arranged in the pattern on the plane of the substrate.

3. The device according to claim 2, wherein the pattern comprises two of the capacitive proximity sensors arranged on a distal portion of the plane, another two of the capacitive proximity sensors arranged on a proximate portion of the plane, and still another two of the capacitive proximity sensors arranged on either side portions of the plane.

4. The device according to claim 1, wherein the controller is a microcontroller.

5. The device according to claim 4, wherein the microcontroller comprises:
an analog front end and multiplexer coupled to the plurality of capacitive proximity sensors;
a capacitance measurement circuit coupled to the analog front end and multiplexer;
an analog-to-digital converter (ADC) having an input coupled to the capacitance measurement circuit;
a digital processor and memory coupled to an output of the ADC; and
a computer interface coupled to the digital processor.

6. The device according to claim 5, wherein the computer interface is a universal serial bus (USB) interface.

7. A method for detecting gestures with a human interface device comprising a plurality of capacitive proximity sensors, said method comprising the steps of:
arranging the plurality of capacitive proximity sensors in a pattern within a sensing plane;
detecting a movement of at least one hand of a user at a distance from the sensing plane with at least two of the capacitive proximity sensors; and
decoding and associating the detected movement to a respective one of a plurality of commands.

8. The method according to claim 7, wherein the plurality of capacitive proximity sensors are six capacitive proximity sensors arranged in the pattern on the sensing plane.

9. The method according to claim 8, wherein top left and top right capacitive proximity sensors are arranged on a distal portion of the sensing plane, bottom left and bottom right capacitive proximity sensors are arranged on a proximate portion of the sensing plane, and left and right capacitive proximity sensors are arranged on either side portions of the sensing plane.

10. The method according to claim 9, wherein a page up command is detected when a hand moves from the right sensor to the left sensor in a sweeping motion, wherein capacitive changes in the right, bottom right, bottom left, and left sensors are detected.

11. The method according to claim 9, wherein a page down command is detected when a hand moves from the left sensor to the right sensor in a sweeping motion, wherein capacitive changes in the left, bottom left, bottom right, and right sensors are detected.

12. The method according to claim 9, wherein a left/right/up/down command is detected when a hand hovers over the sensors and moves in a desired direction of travel, wherein ratio metric changes in the capacitance values of the sensors are detected.

13. The method according to claim 9, wherein a zoom up/down command is detected when a hand hovers over the sensors and moves in or out of a desired direction of travel, wherein ratio metric changes in the capacitance values of the sensor are detected.

14. The method according to claim 9, wherein a clockwise rotation command is detected when at least one hand hovers over the top right/right sensors and the bottom left/left sensors, and then rotates clockwise to the bottom right/right sensors and the top left/left sensors, wherein changes in the capacitance values of the top right/right sensors to the right/bottom right sensors and the bottom left/left sensors to the top left/left sensors are detected.

15. The method according to claim 9, wherein a counter clockwise rotation command is detected when at least one hand hovers over the bottom right/right sensors and the top left/left sensors, and then rotates clockwise to the top right/right sensors and the bottom left/left sensors, wherein changes in the capacitance values of the bottom right/right sensors to the right/top right sensors and the top left/left sensors to the bottom left/left sensors are detected.
